(19) United States
(12) Patent Application Publication
(10) Pub. No.: US 2001/0014700 A1
(43) Pub. Date: Aug. 16, 2001

(54) Aerosol preparation for two-component paint spray cans

(75) Inventor: Peter Kwasny, Schaffhausen (CH)

Correspondence Address: COLLARD & ROE, P.C., 1077 Northern Boulevard, Roslyn, NY, 11576, US

(73) Assignee: Peter Kwasny GmbH

(21) Appl. No.: 09/779,300

(22) Filed: Feb. 8, 2001

(30) Foreign Application Priority Data
Feb. 8, 2000 (DE) 100 05 332.7

(51) Int. Cl. B01F 3/04; B01F 3/06; C08J 3/00; C08K 5/01; C08K 5/02

(52) U.S. Cl. 516/8; 524/768; 525/45

(57) ABSTRACT

An aerosol preparation for two-component paint spray cans, in which the paint material consists of acrylic resins containing OH-groups, and the hardener consists of aliphatic polyisocyanatea. The paint material and hardener are filled in different containers within a spray can and united only immediately before they are processed, and jointly sprayed from the spray can via a propellant consisting of a propane/butane mixture. The weight ratio of diluted paint material to propellant amounts to about 75:25 to 70:30. The paint material consists of OH-group-containing high-solid acrylic resins with a higher solids content and with a mean molecular weight of <5000, and having no styrene and an OH-number of <150.

### BACKGROUND OF THE INVENTION

1. Field of the Invention

The invention relates to an aerosol preparation for two-component paint spray cans, in particular for two-component fillers, special basic paints, two-component one-layer top paints, and two-component clear varnishes. The paint material, which consists of acrylic resins containing OH-groups, and the hardener, which consists of aliphatic polyisocyanates or other substances not containing isocyanate such as polyamides, polyamines, and materials for the Michael addition, are filled in two different containers within a spray can and united only immediately prior to their application. The components are jointly sprayed from the spray can via propellant gas consisting of a propane/butane mixture. The ratio of diluted paint material to propellant gas amounts to 75:25 to 70:30 by weight.

2. The Prior Art

One-component paint materials that dry physically or oxidatively are currently used in aerosol preparations for automotive repair paints. Such paint materials are, for example, synthetic resin paints (oxidatively drying alkyd resins), nitro-paints (nitro combinations with alkyd resins and plasticizers), thermoplastic acrylic paints (TPA paints)(acrylic paints, physically drying thermoplastic acrylic resins), and basic effect paints (single-color, metallic, pearl, CAB-acrylate/polyester combinations). Fluorchlorinated hydrocarbons (FCHCs) have been used as the propellant gas, which has achieved a wide spectrum of compatibility and solubility with the different paint systems.

After the use of FCHCs was prohibited, dimethyl ether or a propane/butane mixture have been increasingly used as the propellant gas in paint spray cans (See German Patent No. DE 38 08 405 C1). However, these propellants have the drawback that propane/butane, for example, is only compatible with the different vehicle systems of the paint materials such as nitro-combination paints up to a defined percent proportion. Beyond a defined proportion, e.g. 75 g diluted paint (up to 70:30) and 25 g propane/butane, the paint is precipitated because propane-butane acts as a non-solvent.

The same occurs with thermoplastic acrylate paints, in which the highly weather-resistant acrylate resins satisfying the specified requirements are incompatible with propane/butane because of their high molecular weight. The low-molecular weight and less hard types, on the other hand, exhibit poor resistance to super gasoline and turn white in the sweat water test (specification of the auto industry). Basic paints that impart effects are almost completely incompatible with propane/butane as well.

Only synthetic paints (oxidatively drying alkyd paints) are compatible with propane/butane mixtures to the highest possible degree. The pressurized propane/butane, which is liquid in the spray can, acts like an aliphatic hydrocarbon (benzine), and air-drying alkyd resins are compatible with aliphates.

Paint repair systems comprising paint from spray cans containing primers, fillers, basic paints for imparting effects, and clear varnish are needed for paint repairs on metal auto bodies (steel, aluminum, zinc) and on plastic automotive components (PP, EPDM, PUR, PA, PC, etc.). Predominantly one-component nitro-type primers or one-component acrylic primers are used as primers in spray cans. However, these primers fail to meet various corrosion specifications with respect to metallic substrates, or in regard to adhesion on plastic components. Only one-component fillers and one-component clear varnishes have been used as fillers and clear varnishes in the form of spray can materials.

A professional auto painter cannot work with these qualities, nor do such single-component products satisfy the specifications of the automobile industry. Fillers are based on nitro combinations (nitro plus alkyd resins or nitro plus acrylate resins). Clear varnishes consist of one-component TPA acrylate resins, which are physically drying without chemical cross-linking.

In the daily practice of auto repair shops, two-component fillers and two-component clear varnishes based on two-component polyurethane (OH-acrylate resins, which are chemically curing by polyisocyanates), are used for paint repair jobs on motor vehicles. These products, which can be processed with a pneumatic spray gun, satisfy all requirements with respect to processing, drying, curing, gloss, levelling, mechanical and chemical resistance, resistance to solvents (super gasoline), and resistance to weathering. Only such two-component products are currently permitted and released by the automobile industry for paint repair work on motor vehicles. Only auto repair shops using such a paint structure meet the legal requirements with respect to restoring a damaged vehicle to its original conditions.

In order to obtain an application and painting rate that can be compared to a high-pressure spray gun, it has been found that a paint spray gun should reach a spray rate of 20 to 22 g spray-ready material in 10 seconds. This technology is the object of DE 196 36 221 C2 and it is employed for single-component paint spray cans for the application of automotive repair paint materials.

In expanding this technology to include also two-component paint sprays, it has been found that all commercially available two-component fillers and two-component clear varnishes are incompatible with propane/butane as the propellant, and that only dinethyl ether (DME) as the propellant leads to results that satisfy the requirements in practical applications. However, the known two-component materials in spray cans pose serious drawbacks for the professional user because of the DME propellant.

Because of the lower pressure of dimethyl ether as compared to propane/butane, it is not possible to work with the usual weight ratio of diluted paint material to propellant of about 75:25. In order to achieve adequate spraying of the paint material and fine atomization, at least a weight ratio of 60:40 is needed between the paint material and the dimethyl ether propellant. This results in a lower range or yield per square meter of painted surface because less paint material and consequently more gas are present in the spray can. The higher propellant component leads to a distinct reduction of the temperature of the paint material due to the evaporation coldness, which in turn causes a drop in pressure and lesser amounts of paint material dispensed, and causes the paint material to exit in uneven amounts dropwise from the spray can. The levelling of the paint is poorer as well, and a high proportion of dry spray mist develops because the proportion of propellant is increased, which impairs levelling of the paint and the gloss. Finally, when using dimethyl ether as the propellant, it is not possible to reach the value of 20 to 22 g per 10 seconds desired for the spray rate. With 16 to 17 g, the spray rate clearly falls short of the desired value.

Exclusively polyester resins or acrylate resins containing OH-groups have been used until now as two-component spray can paint materials because the required chemical curing must take place with aliphatic polyisocyanates. As opposed to the fillers and clear varnishes, aliphatic polyisocyanates are adequately compatible with propane/butane.

All polyester resins containing OH-groups available in the trade for fillers and clear varnishes (two-component), however, are incompatible with propane/butane because polyester resins containing OH-groups have only limited compatibility with aromatics, and exhibit absolute incompatibility to aliphates. This is attributed to the fact that propane/butane acts like an aliphatic solvent under pressure in a spray can. Furthermore, all OH-acrylic resin in commercially available two-component fillers and two-component clear varnishes were found to be not adequately compatible with propane/butane.

Compatibility with propane/butane is determined based on the direct precipitation after filling the propane/butane mixture at the weight ratio of 75:25 to 70:30. The shelf stability of the filled products that were found to pass the spontaneous compatibility test is subsequently tested in an aging test in a drying cabinet, which is carried out over 3 months at 50° C. Only it both tests are successfully completed can it be assumed that the paint spray cans are conforming to market requirements.

Most two-component fillers and two-component clear varnishes available in the market were immediately incompatible with propane/butane. The remainder did not survive the subsequent aging test. A low number of specimens exhibited limited compatibility of 90:10, 85:15, up to maximally 80:20 in terms of weight, which, however, is not sufficient for any spray can application.

Commercially available two-component fillers and two-component clear varnishes are subdivided in so-called low solid (LS) products with a low component of solids, medium solid (MS) products, and high solid (HS) products having a higher proportion of solids. Paint materials With a higher solids component and thus with a low content of evaporating organic solvents are increasingly used because of the future legal VOC-regulations in the European Union (VOC=volatile organic compound).

Two-component MS-paints and two-component MS-fillers and the OH-groups containing acrylate resins contained in these products have, as a rule, a mean molecular weight (mw) of 9000 to 18000. Two-component HS-products have a mean molecular weight of <5000, and two-component LS-products have a mean molecular weight of >15000.

### SUMMARY OF THE INVENTION

It is an object of the invention to provide an aerosol preparation for two-component paint spray cans in which the values specified in DE 196 36 221 C2 for single-component spray cans are achieved with a propellant gas consisting of a propane/butane mixture, and with a mixing ratio of paint material to propellant of about 75:25 to 70:30 by weight.

Superior compatibility with propane/butane is obtained in connection with MS-ON-acrylate resins with the required ratios of 75:25 to 70:30 if exclusively OH-acrylate resins with a low styrene content are used. However, this measure alone will not suffice because a strong dependency on the OH-number (based on solid resin) exists in connection with the compatibility with propane/butane, It has been found that acrylate resins containing OH-groups with an OH-number of <80 exhibit very good compatibility with propane/butane irrespective of their monomer composition. An OH-number from 90 to 140 is still adequate for many applications, whereas an OR-number in excess of 150 is absolutely incompatible.

Increasing or reducing the acid number is not critical with respect to compatibility with propane/butane. Resins with an acid number of between 5 and 30 (mg KOH/kg solid resin) are normally selected. For obtaining good compatibility with propane/butane for all possible types of resin, it is important to carry out a solvent adjustment with a mixture of two parts ester (e.g. butyl acetate) and one part aromatics (e.g. xylene, Solvesso 100).

As a rule, acrylate resins containing OH-groups are synthesized or boiled in aromatics. However, solutions in pure aromatics with 50 to 60% solids are basically poorer than 2:11 ester/aromatics mixtures.

For further diluting to spray viscosity for filling the material in spray cans, ketone/ester mixtures satisfy the required propane/butane compatibility of 75:25 to 70:30. An advantageous adjusting dilution consists of 50% to 55% acetone, 35% to 40% butyl acetate, and 10% to 15% methoxide propylacetate (in terms of weight).

Adjusting dilutions with a 90% to 95% by weight acetone component are normally used for single-component spray cans. These compositions, which are commonly used for two-component fillers and two-component clear varnishes, are disadvantageous both with respect to the compatibility with propane/butane and in regard to levelling, spraying properties, absorption of spray mist, glass, spraying rate and ejection in grams. The dilution specified above for two-component products surprisingly improves all compatibility, application and property parameters specified above.

The concentration, the solids and the spraying viscosity gain important significance for the compatibility with propane/butane in connection with commercially available two-component fillers and two-component clear varnishes. A viscosity of 20 to 24″ levelling viscosity in a DIN beaker with a 3 mm nozzle is good; a spraying viscosity of 21″ is ideal.

### DETAILED DESCRIPTION OF THE PREFERRED EMBODIMENTS

The selection criteria and parameters for adequate compatibility with propane/butane of two-component paint materials, in particular for two-component fillers and two-component clear varnishes, results entirely unexpectedly and surprisingly in three different compositions for satisfying the required mixing ratios of 75:25 to 70:30 by weight:

(1) HS clear varnishes and HS fillers based on OH groups-containing HS acrylic resins with a higher solids content and a medium molecular weight of <5000 mw, preferably of 2500 to 4500, with omission of styrene in the monomer mixture, and with an OH-number of <150, preferably of 130 to 140. Such an aerosol preparation assures adequate reactivity, weather resistance, resistance to chemicals, gloss retention, resistance to solvents, and good chemical cross-linking.

(2) MS clear varnishes and MS fillers with a medium solids content; a low-styrene monomer composition effecting good chemical cross-linking, with an OH-number of between 130 and 140, and with a mean molecular weight of <15000, preferably of 9000 to 13000 mw.

(3) LS clear varnishes and LS fillers with a low solids content and a higher styrene content and with a mean molecular weight of >15000 and an OH-number of <80, preferably from 45 to 60.

An application and working speed with a 20 to 22 g spray rate of spray-ready material in 10 seconds is accomplished in this way and can be compared to a high-pressure spray gun. This technology is the object of DE 196 36 221 C2, the disclosure of which is herein incorporated by reference, and it is applied in conjunction with single-component paint spray cans for the application of automotive repair paint materials.

This means that acrylate resins containing OH-groups have been found by which functioning formulas of 2-component fillers and 2-component clear varnishes have been made possible with the mixing ratios of 75:25 to 70:30 in terms of weight required for their application.

Acrylic resins containing OH-groups and with OH-numbers of from 45 to 60 for two-component fillers and two-component clear varnishes exhibited serious drawbacks in terms of paint technology because of the low OH-number. Only limited chemical cross-linking and curing with aliphatic polyisocyanates is possible due to the low OH-number. Due to their inadequate weather resistance, resistance to solvents and chemicals, as well as curing all the way through with a layer thickness of greater than 45 to 50 μm, the use of two component varnishes is normally excluded in the specifications of the automobile industry, for example because of lack of resistance to super gasoline in connection with automotive paints. With two-component fillers based on these resins, cohesion fractures occurred starting with a layer thickness of 80 μm. Because of the low OH-numbers, these products cure only to two-component PUR-qualities of the second or third quality order. As with the single-component spray can paints, physical drying continues to predominate strongly. Such 2-component fillers and 2-component varnishes of the origin described above are normally not used as quality grades for professional auto paint repair work, but only for industrial applications.

According to the invention, it is possible to eliminate the chemical and other drawbacks in terms of paint technology by cross-linking the OH-group-containing-acrylate resins not according to their OH-number stoichiometrically with aliphatic polyisocyanates as hardeners, but by carrying out a 100 to 300% excess cross-linking. This only retards air and furnace drying within acceptable limits, whereas the resistance to solvents and chemicals and the weather resistance were distinctly enhanced, so that the use of these products as auto repair paint became possible.

Accordingly, while only a few embodiments of the present invention have been shown and described, it is obvious that many changes and modifications may be made thereunto without departing from the spirit and scope of the invention.

What is claimed is:

1. An aerosol preparation for two-component paint spray cans, comprising:
paint material comprising HS (high solid) acrylic resins containing OH-groups and with a high solids content and a mean molecular weight of <5000, wherein said paint material has no styrene and an OH-number of <150;
a hardener comprising aliphatic polyisocyanates said paint material and hardener being filled in two different containers within a spray can, and united only immediately prior to their processing, and
a propane/butane propellant sprayed jointly with the paint material and hardener from the spray can, such that the weight ratio of paint material and hardener to propellant amounts to about 75:25 to 70:30.

2. The aerosol preparation according to claim 1, characterized in that the paint material has an average molecular weight of from 2500 to 4500.

3. The aerosol preparation according to claim 1, wherein the OH-number is between 130 and 140.

4. An aerosol preparation for two-component paint spray cans, comprising:
paint material comprising MS (medium solid) acrylic resins containing OH-groups and having a medium solids content and an average molecular weight of <15000, said paint material having a low component of styrene and an OH-number of between 130 and 140;
a hardener consisting of aliphatic polyisocyanates, said paint material and hardener being filled in two different containers within a spray can and united only immediately before their processing, and
a propellant comprising of a propane/butane mixture for spraying said paint material and hardener from the spray can, wherein the weight ratio of paint material and hardener to propellant amounts to about 75:25 to 70:30.

5. The aerosol preparation according to claim 4, wherein the paint material has an average molecular weight of 9000 to 13000.

6. An aerosol preparation for two-component paint spray cans, comprising:
paint material comprising LS (low solid) acrylic resins containing OH-groups and having a low solids content and a higher styrene content, and with an average molecular weight of >15000 and an OH-number of <80;
a hardener comprising aliphatic polyisocyanates, said paint material and hardener being filled in two different containers within a spray can and united only immediately before their processing; and
a propellant consisting of a propane/butane mixture for jointly spraying the paint material and hardener from the spray can, wherein the weight ratio of paint material and hardener to propellant amounts to about 75:25 to 70:30.

7. The aerosol preparation according to claim 6, wherein the OH-number is between 45 and 60.
